(19) United States
(12) Patent Application Publication
(10) Pub. No.: US 2023/0348226 A1
(43) Pub. Date: Nov. 2, 2023

(54) RADAR-BASED SENSOR DEVICE AND A METHOD FOR REMOVAL OF ELEVATOR CAR SPECIFIC ARTEFACTS FROM RADAR DATA

(71) Applicant: KONE Corporation, Helsinki (FI)

(72) Inventors: Mari ZAKRZEWSKI, HELSINKI (FI); Otto PEKANDER, HELSINKI (FI)

(73) Assignee: KONE Corporation, Helsinki (FI)

(21) Appl. No.: 18/218,817

(22) Filed: Jul. 6, 2023

Related U.S. Application Data
(63) Continuation of application No. PCT/FI2021/050150, filed on Mar. 2, 2021.

(51) Int. Cl. B66B 1/30

(52) U.S. Cl. CPC B66B 1/30

(57) ABSTRACT

A radar-based sensor device for removing elevator car specific artefacts from radar data obtained from inside an elevator car includes a sensor unit and a processing unit. At least the sensor unit is arranged inside the elevator car and configured to transmit radar signals. The processing unit is configured to: obtain from the sensor unit the radar data representing reflected radar signals, and remove elevator car specific artefacts from the obtained radar data based on predefined elevator car specific data. A method, a computer program, and a tangible non-volatile computer-readable medium for removing elevator car specific artefacts from radar data obtained from inside an elevator car are disclosed.

### TECHNICAL FIELD

The invention concerns in general the technical field of elevators. Especially the invention concerns radar-based detection inside elevator cars.

### BACKGROUND

An elevator car may comprise at least one radar-based sensor device arranged inside the elevator car, i.e. at least one in-car radar-based sensor device. However, radar data obtained with the at least one radar-based sensor device may comprise artefacts caused by one or more artefact sources inside the elevator car. Next some example artefact sources inside the elevator car are discussed.

Reflective wall or floor materials such as steel or mirror may cause multipath reflections back to the radar-based sensor device. An elevator car may be considered like a reflection chamber for the radar-based sensor device, where the signal is bouncing from wall to wall. This effect differs for example from a typical office or home environments where the signal travels through the walls with the conventional frequency bands used in the radar-based sensor devices. The different wall and floor materials mean that, in addition to the direct path, the signal may travel back to the sensor-baser radar device after one or more reflections. This may cause ghosts detections.

Alternatively or in addition, an opening or closing movement of the elevator door may be cause false detections of moving passengers, i.e. the opening or closing movement of the elevator door may be mistakenly detected as a moving passenger. The movement of highly reflective surfaces, such as metal elevator doors, may likely cause unstable reflections or sideband reflections.

Alternatively or in addition, a flexible material of the wall of the elevator car may sway during movement of the elevator car, and thus, causing ghosts detections. For example, swaying walls of the elevator car may be mistakenly detected as passengers.

Therefore, there is a need to develop solutions in order to improve at least partly a detection accuracy of an in-car radar-based sensor device.

### SUMMARY

The following presents a simplified summary in order to provide basic under-standing of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a radar-based sensor device, a method, a computer program, and a tangible non-volatile computer-readable medium for removal of elevator car specific artefacts from radar data. Another objective of the invention is that the radar-based sensor device, the method, the computer program, and the tangible non-volatile computer-readable medium for removal of elevator car specific artefacts from radar data improve a detection accuracy of the radar-based sensor device.

The objectives of the invention are reached by a radar-based sensor device, a method, a computer program, and a tangible non-volatile computer-readable medium as defined by the respective independent claims.

According to a first aspect, a radar-based sensor device for removing elevator car specific artefacts from radar data obtained from inside an elevator car is provided, wherein the radar-based sensor device comprises a sensor unit and a processing unit, wherein at least the sensor unit is arranged inside the elevator car and configured to transmit radar signals, the processing unit is configured to: obtain from the sensor unit the radar data representing reflected radar signals, and remove elevator car specific artefacts from the obtained radar data based on predefined elevator car specific data.

The predefined elevator car specific data may comprise 3D location data of interior surfaces of the elevator car in relation to the sensor unit, 3D location data of an elevator door in relation to the sensor unit, and/or a movement data of an elevator door.

The removing of the elevator car specific artefacts may comprise that the processing unit is configured to: define a sensing space based on the predefined elevator car specific data comprising the 3D location data of the interior surfaces of the elevator car in relation to the sensor unit and the 3D location data of the elevator door in relation to the sensor unit, and remove from the radar data radar signals reflected outside the sensing space.

Alternatively or in addition, the removing of the elevator car specific artefacts may comprise that the processing unit is configured to: determine an entering space based on the predefined elevator car specific data comprising the 3D location data of the elevator door in relation to the sensor unit, and remove from the radar data reflected radar signals indicating at least one object entering and/or exiting the elevator car outside the entering space.

Alternatively or in addition, the removing of the elevator car specific artefacts may comprise that the processing unit is configured to: remove from the radar data reflected radar signals indicating a movement of elevator door based on the predefined elevator car specific data comprising the movement data of the elevator door.

The elevator car specific artefacts may be caused by at least one elevator car specific artefact source comprising elevator door and/or at least one interior surface of the elevator car.

The predefined elevator car specific data may be defined during a learning phase before an actual operation of the radar-based sensor device and/or repeatedly during the actual operation of the radar-based sensor device.

The processing unit may further be configured to: obtain elevator related information from at least one other sensor device and/or an elevator control system, and use the obtained elevator related information to activate the transmission of the radar signals, to inactivate the transmission of the radar signals, and/or as additional information in the removal of the elevator related artefacts.

The elevator related information may comprise a movement status of the elevator car and/or a movement status of an elevator door.

The sensor unit may be one of an impulse radar, a pulsed radar, an ultra-wide band (UWB) radar, a stepped frequency continuous wave (CW) radar, or a frequency modulated continuous wave (FMCW) radar.

According to a second aspect, a method for removing elevator car specific artefacts from radar data obtained from inside an elevator car with a radar-based sensor device is provided, wherein the radar-based sensor device comprises a sensor unit and a processing unit, wherein at least the sensor unit is arranged inside the elevator car and transmits radar signals, the method comprises: obtaining, by the processing unit, from the sensor unit the radar data representing reflected radar signals; and removing, by the processing unit, elevator car specific artefacts from the obtained radar data based on predefined elevator car specific data.

The predefined elevator car specific data may comprise 3D location data of interior surfaces of the elevator car in relation to the sensor unit, 3D location data of an elevator door in relation to the sensor unit, and/or a movement data of the elevator car door.

The removing of the elevator car specific artefacts may comprise: defining a sensing space based on the predefined elevator car specific data comprising the 3D location data of the interior surfaces of the elevator car in relation to the sensor unit and the 3D location data of the elevator door in relation to the sensor unit, and removing from the radar data radar signals reflected outside the sensing space.

Alternatively or in addition, the removing of the elevator car specific artefacts may comprise: defining an entering space based on the predefined elevator car specific data comprising the 3D location data of the elevator door in relation to the sensor unit, and removing from the radar data reflected radar signals indicating at least one object entering and/or exiting the elevator car outside the entering space.

Alternatively or in addition, the removing of the elevator car specific artefacts may comprise removing from the radar data reflected radar signals indicating a movement of the elevator door based on the predefined elevator car specific data comprising the movement data of the elevator door.

The elevator car specific artefacts may be caused by at least one elevator car specific artefact source comprising an elevator door and/or at least one interior surface of the elevator car.

The predefined elevator car specific data may be defined during a learning phase before the operation of the radar-based sensor device and/or repeatedly during the operation of the radar-based sensor device.

The method may further comprise: obtaining elevator related information from at least one other sensor device and/or an elevator control system, and using the obtained elevator related information to activate the transmission of the radar signals, to inactivate the transmission of the radar signals, and/or as additional information in the removal of the elevator related artefacts.

The elevator related information may comprise a movement status of the elevator car and/or a movement status of an elevator door.

The sensor unit may be one of an impulse radar, a pulsed radar, an ultra-wide band (UWB) radar, a stepped frequency continuous wave (CW) radar, or a frequency modulated continuous wave (FMCW) radar.

According to a third aspect, a computer program is provided, wherein the computer program comprises instructions which, when the program is executed by a computer, cause the computer to carry out the method as described above.

According to a fourth aspect, a tangible non-volatile computer-readable medium is provided, wherein the tangible non-volatile computer-readable medium comprises the computer program as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically an example of a radar-based sensor device according to the invention.

FIG. 1B schematically illustrates an example of components of a processing unit according to the invention.

FIGS. 2A-2C illustrate non-limiting example installations of a radar-based sensor device or a sensor unit of a radar-based sensor device into an elevator car.

FIG. 3A illustrates schematically an example of a sensing space inside an elevator car.

FIG. 3B illustrates schematically an example of an entering space.

FIG. 4 illustrates schematically an example of a method according to the invention.

FIG. 5 illustrates schematically another example of a method according to the invention.

### DESCRIPTION OF THE EXEMPLIFYING EMBODIMENTS

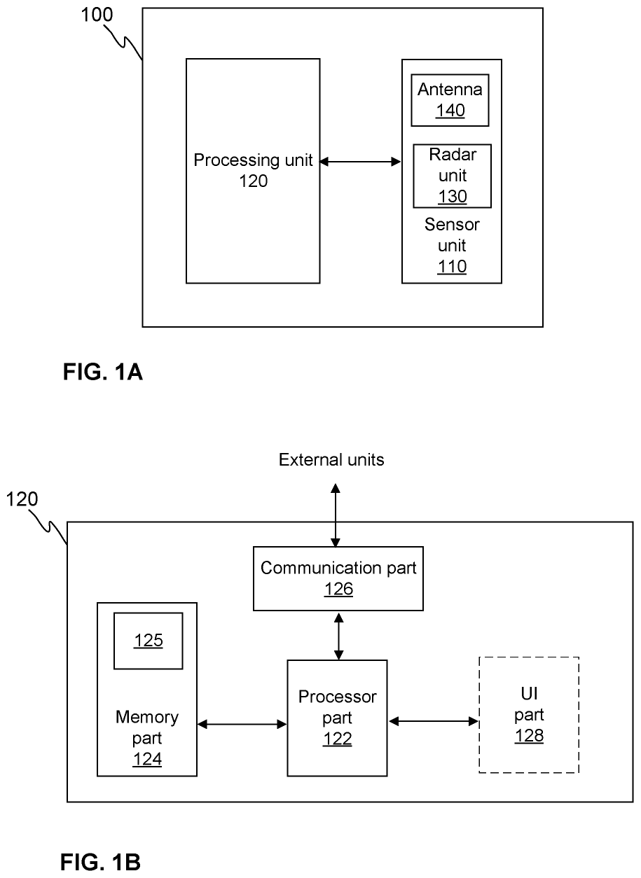

FIG. 1A illustrates schematically an example of a radar-based sensor device 100 according to the invention for removing elevator car specific artefacts from radar data obtained from inside an elevator car 202. The radar-based sensor device 100 comprises a sensor unit 110 and a processing unit 120. The sensor unit 110 may comprise a radar unit 130 and an antenna unit 140. The radar unit 130 may comprise one or more known radar related components, e.g. transmitter unit, receiver unit, duplexer unit, etc. The antenna unit 140 may comprise one or more antennas.

The implementation of the radar-based sensor device 100 may be done as a stand-alone entity or as a distributed environment between a plurality of stand-alone entities, i.e. a distributed system. In other words, the sensor unit 110 and the processing unit 120 of the radar-based sensor device 100 may be implemented physically inside a single entity, e.g. device, or the sensor unit 110 and the processing unit 120 may be implemented as physically separate entities being communicatively coupled to each other. The communication between the sensor unit 110 and the processing unit 120 may be based on one or ore known communication technologies, either wired or wireless.

FIG. 1B schematically illustrates an example of components of the processing unit 120 according to the invention. The processing unit 120 may comprise a processor part 122 comprising one or more processors, a memory part 124 comprising one or more memories, a communication part 126 comprising one or more communication devices, and possibly a user interface (UI) unit 128. The mentioned elements may be communicatively coupled to each other with e.g. an internal bus. The memory part 124 may store and maintain portions of a computer program (code) 125 and any other data. The computer program 125 may comprise instructions which, when the computer program 125 is executed by the processor part 122 of the processing unit 120 may cause the processor part 122, and thus the processing unit 120 to carry out desired tasks, e.g. the operations of the processing unit 120 and/or at least some of the method steps that will be described later in this application. The processor part 122 may thus be arranged to access the memory part 124 and retrieve and store any information therefrom and thereto. For sake of clarity, the processor herein refers to any unit suitable for processing information and control the operation of the processing unit 120, among other tasks. The operations may also be implemented with a microcontroller solution with embedded software. Similarly, the memory part 124 is not limited to a certain type of memory only, but any memory type suitable for storing the described pieces of information may be applied in the context of the present invention. The communication part 126 provides an interface for communication with any external unit, e.g. the sensor unit 110, one or more databases, and/or any other external unit. The communication part 126 may be based on one or more known communication technologies, either wired or wireless, in order to exchange pieces of information. The communication part 126 may comprise one or more communication devices e.g. at least one radio transceiver, at least one antenna, etc. The user interface part 128 may comprise one or more input/output (I/O) devices, such as buttons, keyboard, touch screen, microphone, loudspeaker, display and so on, for receiving user input and outputting information. The computer program 125 may be a computer program product that may be comprised in a tangible non-volatile (non-transitory) computer-readable medium bearing the computer program code 125 embodied therein for use with a computer, i.e. the processing unit 120.

If the radar-based sensor device 100 is implemented as the stand-alone entity, the processor part 122 of the processing unit 120 may be configured to also control the operations of the sensor unit 110. Alternatively or in addition, especially, if the radar-based sensor device 100 is implemented as the distributed system, the sensor unit 110 may comprise a processor unit comprising one or more processors, a memory unit comprising one or more memories, and a communication unit comprising one or more communication devices. The memory unit of the sensor unit 110 may store and maintain portions of a computer program (code) and any other data. The computer program may comprise instructions which, when the computer program is executed by the processor unit of the sensor unit 110 may cause the processor unit, and thus the sensor unit 110 to carry out desired tasks, e.g. the operations of the sensor unit 110.

At least the sensor unit 110 of the radar-based sensor device 100 is arranged, i.e. installed, inside the elevator car 202 for providing radar data from inside the elevator car 202. If the radar-based sensor device 100 is implemented as the stand-alone entity, the whole radar-based sensor device 100 is arranged inside the elevator car 202. Alternatively, if the radar-based sensor device 100 is implemented as the distributed system, at least the sensor unit 110 of the radar-based sensor device 100 is arranged inside the elevator car 202. In this case, the processing unit 120 may also be arranged inside the elevator car 202, but the processing unit 120 may also reside elsewhere, i.e. outside the elevator car 202. If the radar-based sensor device 100 is implemented as the distributed system, the processing unit 120 may for example be an elevator control unit, a cloud server, a remote server, or any other external processing unit.

The sensor unit 110 of the radar-based sensor device 100 according to the invention may for example be one of an impulse radar, a pulsed radar, an ultra-wide band (UWB) radar, a stepped frequency continuous wave (CW) radar, or a frequency modulated continuous wave (FMCW) radar. The radar-based sensor device 100 according to the invention may be used for different sensor applications inside the elevator car 202. In other words, radar data provided with the radar-based sensor device 100 according to the invention may be used for different sensor applications. For example, but not limited to, the radar-based sensor device 100 according to the invention may be used for detecting an elevator door 204 state, e.g. open, closed, opening, or closing; detecting an item between an elevator door 204; counting number of passengers entering to the elevator car 202, exiting from the elevator car 202 and/or residing in the elevator car 202; detecting entrapment situations; and/or detecting a fill level of the elevator car 202. The use of the radar-based sensor device 100 according to the invention for one or more sensor applications inside the elevator car 202 enables an improved privacy for example in comparison to a camera or image recognition-based detection.

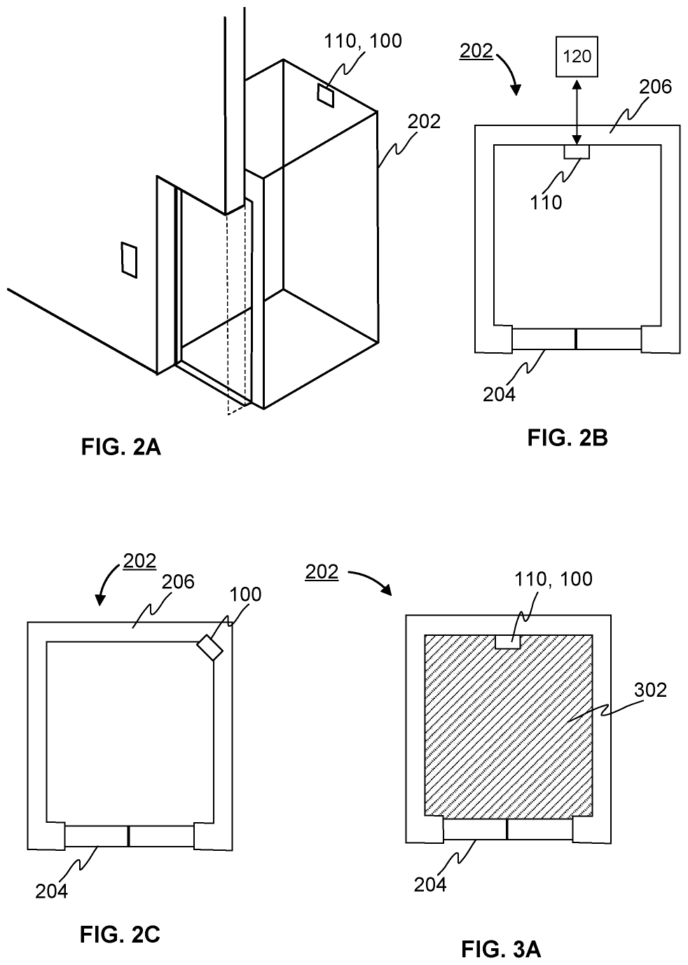

FIGS. 2A-20 illustrate schematically non-limiting example installations of the radar-based sensor device 100 or the sensor unit of a radar-based sensor device 100 into the elevator car 202. In other words, FIGS. 2A-2C illustrate non-limiting examples of the elevator car 202 into which the sensor unit 110 of the radar-based sensor device 100 or the whole radar-based sensor device 100 may be arranged. FIG. 2A illustrates a perspective view of the elevator car 202. FIGS. 2B and 20 illustrate a top view of the elevator car 202. In the example of FIGS. 2A-20, the elevator door 204 is a center opening elevator door comprising two door leaves, i.e. panels. However, the invention is not limited to that and the elevator door 204 may also be a left or right opening elevator door comprising one door leaf. The example of FIG. 2A illustrates one example for arranging the sensor unit 110 of the radar-based sensor device 100 or the whole radar-based sensor device 100 inside the elevator car 202. In the example of FIG. 2A the sensor unit 110 of the radar-based sensor device 100 or the whole radar-based sensor device 100 is arranged, i.e. installed, on the back wall 206 of the elevator car 202.

If the radar-based sensor device 100 is implemented as the distributed system, the sensor unit 110 of the radar-based sensor device 100 may be arranged inside the elevator car 202 at different locations. For example, the sensor unit 110 may be arranged on a ceiling of the elevator car 202 or on a wall of the elevator car 202, e.g. the back wall, i.e. the wall being opposite to an elevator door 204 of the elevator car 202, or to a back corner of the elevator car 202. The sensor unit 110 may preferably be arranged at least close to the ceiling of the elevator car 202. Alternatively or in addition, the sensor unit 110 may preferably be arranged inside the elevator car 202 so that the sensor unit 110 is facing towards the elevator door 204 of the elevator car 202. In other words, the sensor unit 110 may preferably be arranged inside the elevator car 202 so that the sensor unit 110 is able to transmit radar signals towards the elevator door 204. FIG. 2B illustrates schematically an example for arranging the sensor unit 110 of the radar-based sensor device 100 inside the elevator car 202, when the radar-based sensor device 100 is implemented as the distributed system. In the example of FIG. 2B the sensor unit 110 of the radar-based sensor device 100 is arranged on the back wall 206 of the elevator car 202. In the example of FIG. 2B, the sensor unit 110 is communicatively coupled to the processing unit 120 residing outside the elevator car 202, i.e. being external to the sensor unit 110. Similarly, if the radar-based sensor device 100 is implemented as the stand-alone entity, the whole radar-based sensor device 100 may be arranged inside the elevator car 202 at different locations. For example, the whole radar-based sensor device 100 may be arranged on the ceiling of the elevator car 202 or on a wall of the elevator car 202, e.g. the back wall, or to a back corner of the elevator car 202. The whole radar-based sensor device 100 may preferably be arranged at least close to the ceiling of the elevator car 202. Alternatively or in addition, the whole radar-based sensor device 100 may preferably be arranged inside the elevator car 202 so that the sensor unit 110 is facing towards the elevator door 204 of the elevator car 202. In other words, the whole radar-based sensor device 100 may preferably be arranged inside the elevator car 202 so that the sensor unit 110 is able to transmit radar signals towards the elevator door 204. FIG. 2C illustrates schematically an example for arranging the (whole) radar-based sensor device 100 comprising the sensor unit 110 and the processing unit 120 inside the elevator car 202, when the radar-based sensor device 100 is implemented as the stand-alone entity. In the example of FIG. 2C the radar-based sensor device 100 is arranged on the back corner of the elevator car 202. The location of the sensor unit 110 of the radar-based sensor device 100 and/or the whole radar-based sensor device 100 inside the elevator car 202 may depend on the purpose of the use of the radar-based sensor device 100. At least the sensor unit 110 or the whole radar-based sensor device 100 may be hidden behind an interior surface of the ceiling or an interior surface of the wall material enabling that the sensor unit 110 and/or the whole radar-based sensor device 100 is not affecting the elevator car interior design. Moreover, the radar-based sensor device 100 does not require cleaning, which reduces the maintenance costs.

The sensor unit 110 arranged inside the elevator car 202 is configured to transmit radar signals. The sensor unit 110 is further configured to receive reflected radar signals. The reflected radar signals may comprise the radar signals reflected from one or more objects inside the elevator car 202, e.g. internal surfaces of the elevator car 202, the elevator door 204, one or more passengers. Moreover, if the elevator door 204 is open, the reflected radar signals may further comprise radar signals reflected from outside the elevator car 204, e.g. from surfaces, passengers, and/or any other objects outside the elevator car 202.

The processing unit 120 is configured to obtain from the sensor unit 110 radar data representing the reflected radar signals. In other words, the sensor unit 110 is configured to provide radar data representing the received reflected radar signals to the processing unit 120. The sensor unit 110 may provide the radar data to the processing unit 120 continuously, e.g. in response to receiving the reflected signals. Alternatively, the sensor unit 110 may provide the radar data to the processing unit 120 periodically, e.g. at regular or irregular intervals. In other words, the sensor unit 110 may buffer, i.e. store, the received radar data and provide at once the stored received radar data comprising reflected radar signals received over a period of time, e.g. since the radar data was previously provided to the processing unit 120. The sensor unit 110 may comprise the memory unit for storing the radar data to be provided periodically to the processing unit 120. The radar data may comprise locations of reflection points in a three-dimensional (3D) space for each time instant. In other words, the radar data may comprise a 3D-matrix for each time instant comprising values of the reflected radar signal, e.g. an amplitude and a phase of the reflected radar signal, from each distance, each elevation angle value, and each azimuth angle value.

The obtained radar data may comprise artefacts caused by at least one elevator car specific artefact source. In other words, the radar data may comprise elevator specific artefacts. The at least one elevator car specific artefact source may comprise the elevator door 204 and/or at least one interior surface of the elevator car 202. Next some example artefact sources inside the elevator car 202 and different elevator related artefacts are discussed. Reflective wall, ceiling or floor materials, such as steel or mirror, may cause multipath reflections back to sensor unit 110. Thus, in addition to the direct path, the radar signals may travel back to the sensor unit 110 after one or more reflections. This may be called as a multipath effect. The multipath effect may cause elevator related artefacts to the radar data, which in turn may lead for example to ghosts detections. Alternatively or in addition, for example an opening or a closing movement of the elevator door 204 may be cause false detections of moving passengers. In other words, the opening or closing movement of the elevator door 204 may cause elevator related artefacts to the radar data, which in turn may lead for example to a false detection of as a moving passenger. The movement of highly reflective surfaces, such as metal elevator door 204, may cause for example unstable reflections or sideband reflections. Alternatively or in addition, a flexible material of the walls of the elevator car 204 may sway during the movement of the elevator car 202, and cause multipath effect causing elevator related artefacts to the radar data, which in turn may lead for example to ghosts detections. For example, the swaying wall(s) of the elevator car 202 may lead to a false detection of a passenger.

The processing unit 120 is further configured to remove the elevator car specific artefacts at least partly from the obtained radar data based on predefined elevator car specific data. The removal of the elevator car specific artefacts from the obtained radar data improves the detection accuracy of the radar-based sensor device 100. The predefined elevator car specific data may comprise 3D location data of interior surfaces of the elevator car 202 in relation to the sensor unit 110, 3D location data of the elevator door 204 in relation to the sensor unit 110, and/or a movement data of the elevator door 204. The interior surfaces of the elevator car 202 may comprise interior surfaces of the walls of the elevator car 202, an interior surface of the ceiling of the elevator car 202, and/or an interior surface of the floor of the elevator car 202. The 3D location data of an elevator car related object (e.g. the interior surface of the elevator car 202 or the elevator door 204) in relation to the sensor unit 110 may comprise a group of distances and aspect angles between multiple points of object and the sensor unit 110.

The predefined elevator car specific data may be defined during a learning phase before an actual operation of the radar-based sensor device 100. The learning phase may be performed for example after the installation of the radar-based sensor device 100. Alternatively, the predefined elevator car specific data may be defined repeatedly during the actual operation of the radar-based sensor device 100. With the term “actual operation of the radar-based sensor device 100” is meant throughout this application one or more operations of the radar-based sensor device 100 in which the radar-based sensor device 100 according to the invention provides the radar data and/or uses the provided radar data in different sensor applications. The learning phase and/or the repeatable definition of the predefined elevator car specific data need to be performed for each elevator car 202 separately as the sizes of the elevator cars 202, the dimensions of the elevator cars 202, and/or installation placements of the radar-based sensor device 100 may vary depending on the elevator car 202 to which the radar-based sensor device 100 is arranged.

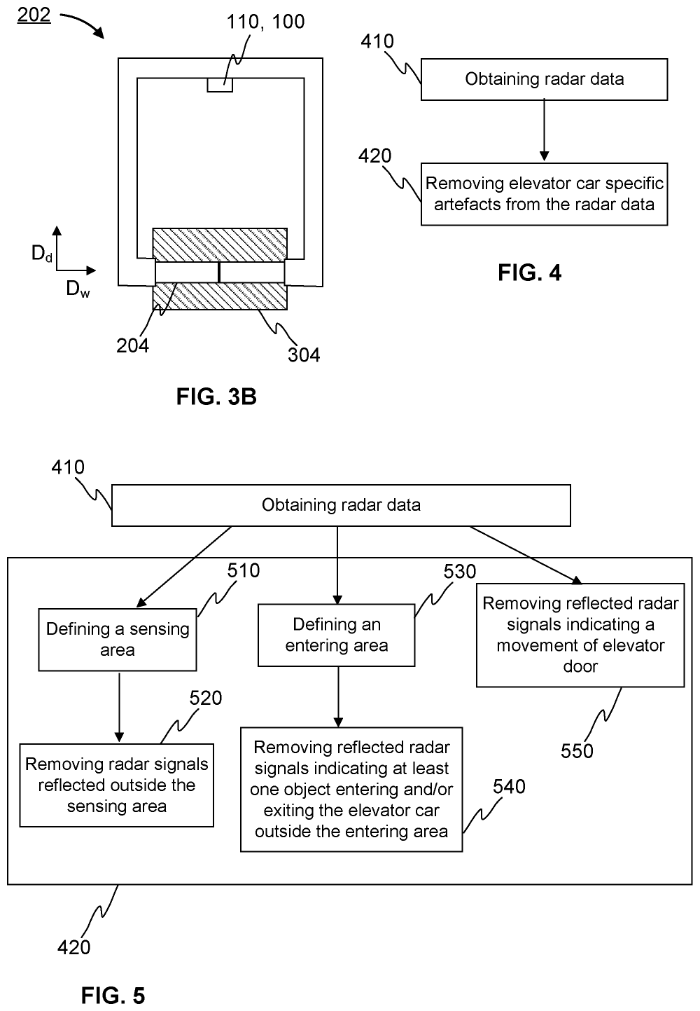

The removing of the elevator car specific artefacts may comprise that the processing unit 120 may be configured to define a sensing space 302 based on the predefined elevator car specific data, wherein the predefined elevator car specific data comprises the 3D location data of the interior surfaces of the elevator car 202 in relation to the sensor unit 110 and the 3D location data of the elevator door 204 in relation to the sensor unit 110, and to remove from the radar data radar signals reflected outside the sensing space 302. The sensing space 302 may be defined by defining the 3D locations of the interior surfaces of the elevator car 202 and the 3D location of the elevator door 204 viewed from the sensor unit 110. In other words, the sensing space 302 may cover a space limited by the interior surfaces of the elevator car 202 and the elevator door 204. As discussed above the multipath effect may lead to ghost detections. However, the majority of ghost detections are formed outside the elevator car 202, because the ghost detections are always formed at a distance further to the sensor unit 110 than real objects residing inside the elevator car 202, e.g. one or more passengers and/or load. Thus, the reflected radar signals from outside the sensing space 302 (e.g. vibrating walls) may be considered to be elevator car specific artefacts and removed from radar data. FIG. 3A illustrates schematically an example of the sensing space 302 inside the elevator car 202. FIG. 3A illustrates a top view of the sensing space 302.

Alternatively or in addition, the removing of the elevator car specific artefacts may comprise that the processing unit 120 may be configured to determine an entering space 304 based on the predefined elevator car specific data, wherein the predefined elevator car specific data comprises the 3D location data of the elevator door 204 in relation to the sensor unit 110, and to remove from the radar data reflected radar signals indicating at least one object, e.g. a passenger and/or load, entering and/or exiting the elevator car 202 outside the entering space 304. The entering space 304 may reside substantially in a vicinity, i.e. a proximity, of the elevator door 204. In other words, the entering space 304 may cover at least the doorway of the elevator door 204. Preferably, in a depth direction D_{d}, the entering space 304 may extent at least partly inside the elevator car 202 and at least partly outside the elevator car 202, e.g. to an elevator lobby outside of the elevator car 202. Preferably, in a horizontal direction D_{w}, the entering space 304 may extend at least across the width of the elevator door 204. In other words, the width of the entering space 304 may correspond at least the width of the elevator door 204. In a vertical direction (not shown in FIG. 3B), the entering space 304 may extend for example from the floor of the elevator car 202 to the ceiling of the elevator car 202. The entering space 304 is the only place from which objects are able to enter and/or exit the elevator car 202, because the objects may enter and/or exit the elevator car 202 only through the doorway. The objects cannot enter and/or or exit the elevator car 202 through the walls, the floor, and/or ceiling of the elevator car 202.

Moreover, the objects cannot disappear during an elevator ride, i.e. during the movement of the elevator car 202. FIG. 3B illustrates schematically an example of the entering space 304. FIG. 3B illustrates a top view of the entering space 304.

Alternatively or in addition, the removing of the elevator car specific artefacts may comprise that the processing unit 120 may be configured to remove from the radar data reflected radar signals indicating a movement of the elevator door 204 based on the predefined elevator car specific data, wherein the predefined elevator car specific data comprises the movement data of the elevator door 204. In other words, the processing unit 120 may be configured to remove from the radar data reflected radar signals caused by the movement of the elevator door 204. The reflected radar signals caused by the movement of the elevator door 204 may be detected and separated from the reflections caused by one or more objects residing and/or moving inside the elevator car 202, e.g. one or more passengers or load, and thus removed from the radar data.

According to an example, the processing unit 120 may further be configured to obtain elevator related information. The processing unit 120 may further be configured to use the obtained elevator related information to activate the transmission of the radar signals and/or inactivate the transmission of the radar signals. Alternatively or in addition, the processing unit 120 may further be configured to use the obtained elevator related information as additional information in the removal of the elevator related artefacts. The obtained elevator related information may comprise for example a movement status of the elevator car 202 and/or a movement status of the elevator door 202. Use of the obtained elevator related information may improve the detection accuracy with the radar-based sensor device 100. For example, when the elevator related information indicates that the elevator car 202 is moving, a door movement detection by the radar-based sensor device 100 may be inactivated. Alternatively or in addition, when the elevator related information indicates that the elevator car 202 is decelerating, the transmission of the radar signals may be activated for activating the door movement detection as the opening the elevator door 204 starts shortly after the deceleration of the elevator car 202. Alternatively or in addition, the movement data of the elevator car 202 may be used as the additional information in the removal of the reflected radar signals indicating at least one object entering and/or exiting the elevator car 202 during the movement of the elevator car 202, because the number of objects, e.g. passengers, inside the elevator car 202 will not change during the movement of the elevator car 202. According to another example, the movement data of the elevator door 204 may be used as the additional information in the removal of the elevator related artefacts caused by the movement of the elevator door 204. The elevator related information may be obtained from at least one other sensor device and/or an elevator control system. The one or more other sensor devices may be arranged to the elevator car 202. For example, a sensor device, e.g. an acceleration sensor, may be arrange to the elevator car 202 to obtain the movement status of the elevator car 202. Alternatively or in addition, a sensor device, e.g. an acceleration sensor, may be arranged to the elevator door 204 to obtain the movement status of the elevator door 204.

The invention is described above referring to the radar-based sensor device 100. However, the invention relates also to a method for removing elevator car specific artefacts from radar data obtained from inside the elevator car 202 with the radar-based sensor device 100 as described above. Next an example of a method according to the invention is described by referring to FIG. 4. FIG. 4 schematically illustrates the invention as a flow chart.

As discussed above, the sensor unit 110 arranged inside the elevator car 202 transmits radar signals and further receives reflected radar signals. The sensor unit 110 of the radar-based sensor device 100 may for example be one of an impulse radar, a pulsed radar, an ultra-wide band (UWB) radar, a stepped frequency continuous wave (CW) radar, or a frequency modulated continuous wave (FMCW) radar.

At a step 410, the processing unit 120 obtains from the sensor unit 110 the radar data representing reflected radar signals. In other words, the sensor unit 110 provides radar data representing the received reflected radar signals to the processing unit 120. The sensor unit 110 may provide the radar data to the processing unit 120 continuously or periodically as discussed above. The obtained radar data may comprise artefacts caused by at least one elevator car specific artefact source. In other words, the radar data may comprise elevator specific artefacts. The at least one elevator car specific artefact source may comprise the elevator door 204 and/or at least one interior surface of the elevator car 200 as discussed above.

At a step 420, the processing unit 120 removes elevator car specific artefacts from the obtained radar data based on predefined elevator car specific data. The predefined elevator car specific data may comprise 3D location data of interior surfaces of the elevator car 202 in relation to the sensor unit 110, 3D location data of the elevator door 204 in relation to the sensor unit 110, and/or a movement data of the elevator door 204 as discussed above. The interior surfaces of the elevator car 202 may comprise interior surfaces of the walls of the elevator car 202, an interior surface of the ceiling of the elevator car 202, and/or an interior surface of the floor of the elevator car 202. The predefined elevator car specific data may be defined during a learning phase before an actual operation of the radar-based sensor device 100. The learning phase may be performed for example after the installation of the radar-based sensor device 100 or the predefined elevator car specific data may be defined repeatedly during the actual operation of the radar-based sensor device 100 as discussed above.

FIG. 5 illustrates schematically flow chart of FIG. 4 in more detailed manner. Especially the step 420 becomes clear from FIG. 4. The removing of the elevator car specific artefacts at the step 420 may comprise that the processing unit 120 defines 510 a sensing space 302 based on the predefined elevator car specific data, wherein the predefined elevator car specific data comprises the 3D location data of the interior surfaces of the elevator car 202 in relation to the sensor unit 110 and the 3D location data of the elevator door 204 in relation to the sensor unit 110 and removes 520 from the radar data radar signals reflected outside the sensing space 302. The sensing space 302 may be defined by defining the 3D locations of the interior surfaces of the elevator car 202 and the 3D location of the elevator door 204 viewed from the sensor unit 110. In other words, the sensing space 302 may cover a space limited by the interior surfaces of the elevator car 202 and the elevator door 204. The reflected radar signals from outside the sensing space 302 (e.g. vibrating walls) may be considered to be elevator car specific artefacts and removed from radar data as discussed above.

Alternatively or in addition, the removing of the elevator car specific artefacts at the step 420 may comprise that the processing unit 120 determines 530 an entering space 304 based on the predefined elevator car specific data, wherein the predefined elevator car specific data comprises the 3D location data of the elevator door 204 in relation to the sensor unit 110, and removes 540 from the radar data reflected radar signals indicating at least one object, e.g. a passenger and/or load, entering and/or exiting the elevator car 202 outside the entering space 304. The entering space 304 may reside substantially in a vicinity, i.e. a proximity, of the elevator door 204 as discussed above.

Alternatively or in addition, the removing of the elevator car specific artefacts at the step 420 may comprise that the processing unit 120 removes 550 from the radar data reflected radar signals indicating a movement of the elevator door 204 based on the predefined elevator car specific data, wherein the predefined elevator car specific data comprises the movement data of the elevator door 204. In other words, the processing unit 120 may remove from the radar data reflected radar signals caused by the movement of the elevator door 204. The reflected radar signals caused by the movement of the elevator door 204 may be detected and separated from the reflections caused by one or more objects residing and/or moving inside the elevator car 202, e.g. one or more passengers or load, and thus removed from the radar data.

According to an example, the method may further comprise obtaining elevator related information. The method may further comprise using the obtained elevator related information to activate the transmission of the radar signals and/or inactivate the transmission of the radar signals as discussed above. Alternatively or in addition, the method may further comprise using the obtained elevator related information as additional information in the removal of the elevator related artefacts as discussed above. The obtained elevator related information may comprise for example a movement status of the elevator car 202 and/or a movement status of the elevator door 202. Use of the obtained elevator related information may improve the detection accuracy with the radar-based sensor device 100.

The specific examples provided in the description given above should not be construed as limiting the applicability and/or the interpretation of the appended claims. Lists and groups of examples provided in the description given above are not exhaustive unless otherwise explicitly stated.

1. A radar-based sensor device for removing elevator car specific artefacts from radar data obtained from inside an elevator car, the radar-based sensor device comprising:
a sensor unit, and
a processing unit,
wherein at least the sensor unit is arranged inside the elevator car and is configured to transmit radar signals, and
wherein the processing unit is configured to:
obtain the radar data representing reflected radar signals from the sensor unit; and
remove elevator car specific artefacts from the obtained radar data based on predefined elevator car specific data.

2. The radar-based sensor device according to claim 1, wherein the predefined elevator car specific data comprises 3D location data of interior surfaces of the elevator car in relation to the sensor unit, 3D location data of an elevator door in relation to the sensor unit, and/or movement data of an elevator door.

3. The radar-based sensor device according to claim 2, wherein the removing of the elevator car specific artefacts comprises that the processing unit is configured to:
define a sensing space based on the predefined elevator car specific data comprising the 3D location data of the interior surfaces of the elevator car in relation to the sensor unit (110) and the 3D location data of the elevator door in relation to the sensor unit; and
remove from the radar data radar signals reflected outside the sensing space.

4. The radar-based sensor device according to claim 2, wherein the removing of the elevator car specific artefacts comprises that the processing unit is configured to:
determine an entering space based on the predefined elevator car specific data comprising the 3D location data of the elevator door in relation to the sensor unit; and
remove from the radar data reflected radar signals indicating at least one object entering and/or exiting the elevator car outside the entering space.

5. The radar-based sensor device according to claim 2, wherein the removing of the elevator car specific artefacts comprises that the processing unit is configured to:
remove from the radar data reflected radar signals indicating a movement of the elevator door based on the predefined elevator car specific data comprising the movement data of the elevator door.

6. The radar-based sensor device according to claim 1, wherein the elevator car specific artefacts are caused by at least one elevator car specific artefact source comprising the elevator door and/or at least one interior surface of the elevator car.

7. The radar-based sensor device according to claim 1, wherein the predefined elevator car specific data is defined during a learning phase before an actual operation of the radar-based sensor device and/or repeatedly during the actual operation of the radar-based sensor device.

8. The radar-based sensor device according to claim 1, wherein the processing unit is further configured to:
obtain elevator related information from at least one other sensor device and/or an elevator control system; and
use the obtained elevator related information to activate the transmission of the radar signals, to inactivate the transmission of the radar signals, and/or as additional information in the removal of the elevator related artefacts.

9. The radar-based sensor device according to claim 8, wherein the elevator related information comprises a movement status of the elevator car and/or a movement status of an elevator door.

10. The radar-based sensor device according to claim 1, wherein the sensor unit is one of an impulse radar, a pulsed radar, an ultra-wide band (UWB) radar, a stepped frequency continuous wave (CW) radar, or a frequency modulated continuous wave (FMCW) radar.

11. A method for removing elevator car specific artefacts from radar data obtained from inside an elevator car with a radar-based sensor device, wherein the radar-based sensor device comprises a sensor unit and a processing unit wherein at least the sensor unit is arranged inside the elevator car and transmits radar signals, the method comprising:
obtaining, by the processing unit, the radar data representing reflected radar, signals from the sensor unit; and
removing, by the processing unit, elevator car specific artefacts from the obtained radar data based on predefined elevator car specific data.

12. The method according to claim 11, wherein the predefined elevator car specific data comprises 3D location data of interior surfaces of the elevator car in relation to the sensor unit, 3D location data of an elevator door in relation to the sensor unit, and/or a movement data of the elevator car door.

13. The method according to claim 12, wherein the removing of the elevator car specific artefacts comprises:
defining a sensing space based on the predefined elevator car specific data comprising the 3D location data of the interior surfaces of the elevator car in relation to the sensor unit and the 3D location data of the elevator door in relation to the sensor unit; and
removing from the radar data radar signals reflected outside the sensing space.

14. The method according to claim 12, wherein the removing of the elevator car specific artefacts comprises:
defining an entering space based on the predefined elevator car specific data comprising the 3D location data of the elevator door in relation to the sensor unit; and
removing from the radar data reflected radar signals indicating at least one object entering and/or exiting the elevator car outside the entering space.

15. The method according claim 12, wherein the removing of the elevator car specific artefacts comprises removing from the radar data reflected radar signals indicating a movement of the elevator door based on the predefined elevator car specific data comprising the movement data of the elevator door.

16. The method according to claim 11, wherein the elevator car specific artefacts are caused by at least one elevator car specific artefact source comprising an elevator door and/or at least one interior surface of the elevator car.

17. The method according to claim 11, wherein the predefined elevator car specific data is defined during a learning phase before the operation of the radar-based sensor device and/or repeatedly during the operation of the radar-based sensor device.

18. The method according to claim 11, further comprising:
obtaining elevator related information from at least one other sensor device and/or an elevator control system; and
using the obtained elevator related information to activate the transmission of the radar signals, to inactivate the transmission of the radar signals, and/or as additional information in the removal of the elevator related artefacts.

19. The method according to claim 18, wherein the elevator related information comprises a movement status of the elevator car and/or a movement status of an elevator door.

20. The method according to claim 11, wherein the sensor unit is one of an impulse radar, a pulsed radar, an ultra-wide band (UWB) radar, a stepped frequency continuous wave (CW) radar, or a frequency modulated continuous wave (FMCW) radar.

21. A computer program embodied on a non-transitory computer readable medium and comprising instructions which, when the program is executed by a computer, cause the computer to carry out the method according to claim 11.

22. (canceled)
